(19) United States
(12) Patent Application Publication
(10) Pub. No.: US 2002/0092386 A1
(43) Pub. Date: Jul. 18, 2002

(54) Handle structure for hand tools

(76) Inventor: Yi-Ting Lin, (US)

Correspondence Address: Charles E. Baxley, 59 John Street, 5th Floor, New York, NY, 10038, US

(21) Appl. No.: 09/969,353

(22) Filed: Oct. 3, 2001

(30) Foreign Application Priority Data
Oct. 13, 2000 (TW) 89217923

(51) Int. Cl. B25B 23/16

(52) U.S. Cl. 81/177.1

(57) ABSTRACT

A hand tool includes a handle having a recessed surface defined in a side thereof and two threaded holes are defined in the recessed surface. A handle piece has two protrusions extending from a bottom thereof and each protrusion has a threaded passage so that screws are engaged with the threaded passages and the threaded holes to connect the handle piece to the handle of the hand tool.

### FIELD OF THE INVENTION

The present invention relates to a hand tool such as a wrench and a handle piece is connected to a side of the handle of the tool by bolts so as to provide a comfortable grab for the users.

### BACKGROUND OF THE INVENTION

A conventional wrench 10 is shown in FIG. 1 and generally includes handle portion 11 and a function end which includes a hole 101 in which a ratchet mechanism is received and a cap 12 is connected to the function end so as to retain the ratchet mechanism. An engaging shaft 15 of the ratchet mechanism extends from the cap 12. The handle portion 11 is made by metal so that it is cold when the user holds the handle portion 11 especially in the winter. This is not comfortable for the users. In order to improve the shortcoming, a sleeve 14 made of rubber is mounted to the handle portion 11 and the rubber sleeve 14 is supposed to provide a better grab feature. Nevertheless, the size of the handle portion 11 often varies dramatically because it is not necessary to be made with a higher standard. Therefore, the sleeves 14 cannot be fit on the handles portion 11 as desired.

### SUMMARY OF THE INVENTION

In accordance with one aspect of the present invention, there is provided a hand tool which comprises a handle having a recessed surface defined in a side thereof and a plurality of threaded holes are defined in the recessed surface. A handle piece has a plurality of protrusions extending from a bottom thereof and each protrusion has a threaded passage defined therethrough. Screws are engaged with the threaded passages and the threaded holes.

The primary object of the present invention is to provide a handle piece which is conveniently connected to a side of the handle of a hand tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show a conventional hand tool with a handle portion;

FIG. 2 is an exploded view to show a sleeve and a conventional hand tool;

FIG. 3 is an exploded view to show a hand tool and a handle piece of the present invention, and

FIG. 4 is a cross sectional view to show the connection of the handle piece and the hand of the tool.

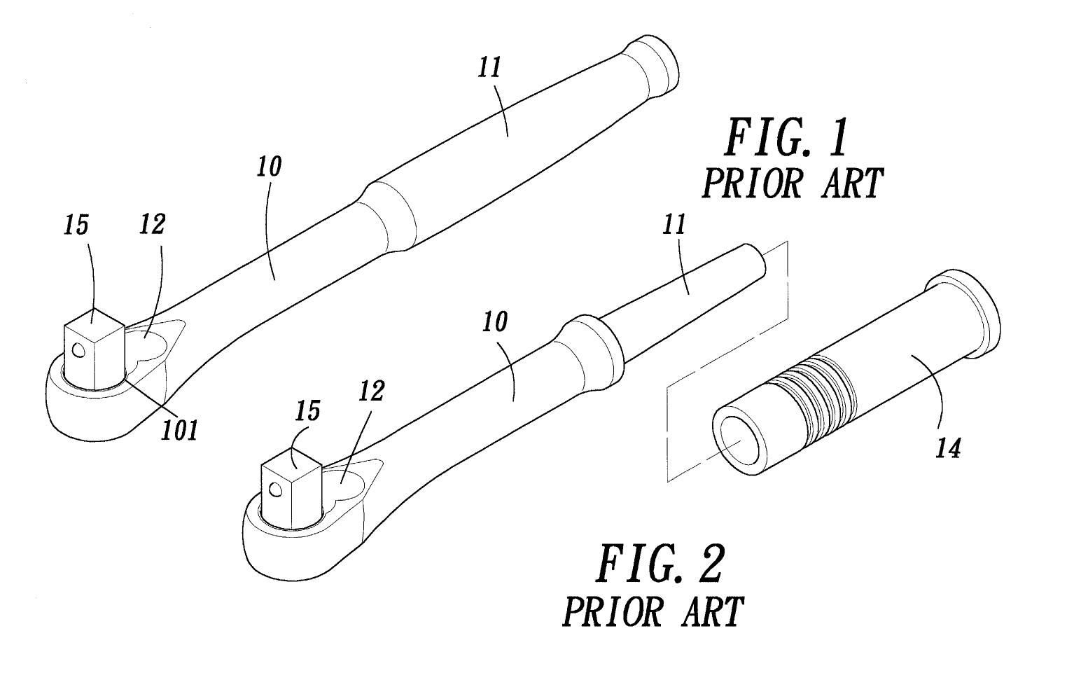

### DETAILED DESCRIPTION OF THE PREFERRED EMBODIMENT

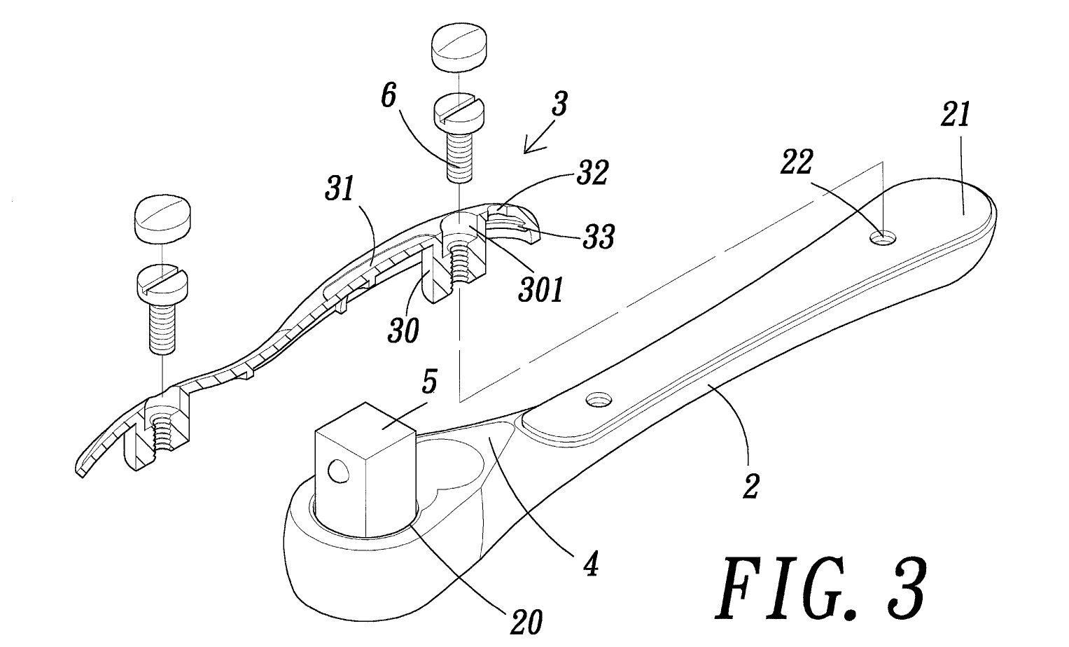

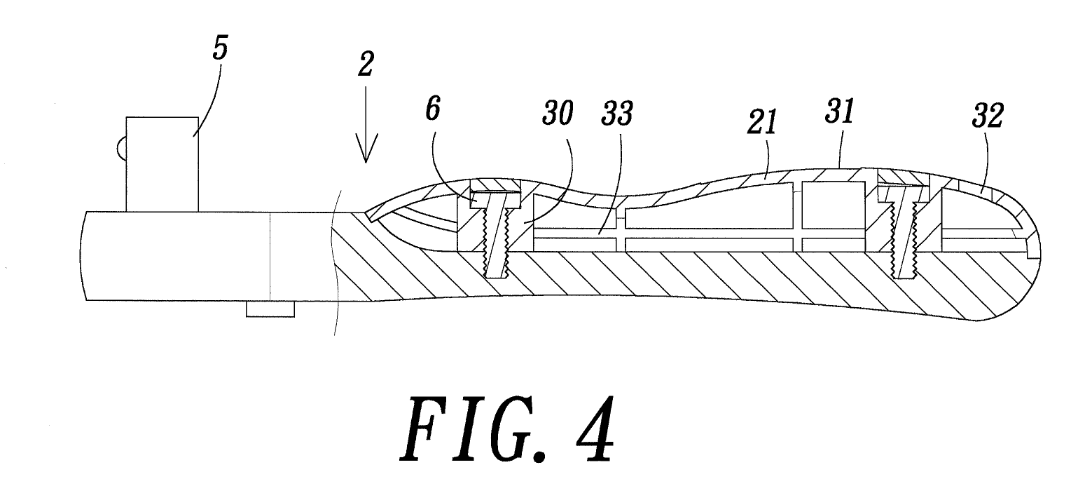

Referring to FIGS. 3 and 4, a hand tool has a handle 2 and a function end which has a hole 20 for receiving a ratchet mechanism therein. The ratchet mechanism is retained in position by a cap 4 mounted to a side of the function end and an engaging shaft 5 of the ratchet mechanism extends from the cap 4.

The handle 2 has a recessed surface 21 defined in a side thereof and two threaded holes 22 are defined in the recessed surface 21. A handle piece 3 has two protrusions 30 extending from a bottom thereof and each protrusion 30 has a threaded passage defined therethrough. Two screws 6 are engaged with the threaded passages and the threaded holes 22 to connect the handle piece 3 to the handle 2

Two sink holes 301 are respectively defined in the handle piece 3 and communicate with the two threaded passages so that the heads of the screws 6 are engaged with the sink holes 301. A flange 33 extends inward from an inner periphery of the handle piece 3 so as to reinforce the structural strength of the handle piece 3. A recess 31 is defined in a top of the handle piece 3 so as to receive a brand label therein and a hanging hole 32 is defined in the top of the handle piece 3 such that the hand tool can be hanged by the hanging hole 32.

The handle piece 3 is conveniently connected to the handle 2 of the hand tool and the handle piece 3 can be made by soft and anti-slip material so as to provide a comfortable grab.

While we have shown and described the embodiment in accordance with the present invention, it should be clear to those skilled in the art that further embodiments may be made without departing from the scope of the present invention.

What is claimed is:

1. A hand tool comprising:
a handle having a recessed surface defined in a side thereof and a plurality of threaded holes defined in said recessed surface, and
a handle piece having a plurality of protrusions extending from a bottom thereof and each protrusion having a threaded passage defined therethrough, screws engaged with said threaded passages and said threaded holes.

2. The hand tool as claimed in claim 1 further comprising a plurality of sink holes defined in said handle piece and respectively communicating with said threaded passages.

3. The hand tool as claimed in claim 1 further comprising a flange extending inward from an inner periphery of said handle piece.

4. The hand tool as claimed in claim 1 further comprising a recess defined in a top of said handle piece.

5. The hand tool as claimed in claim 1 further comprising a hanging hole defined in a top of said handle piece.
